(19) United States
(12) Patent Application Publication
(10) Pub. No.: US 2020/0148919 A1
(43) Pub. Date: May 14, 2020

(54) PORTABLE ELECTRONIC DEVICE AND PRESSURE-SENSITIVE ADHESIVE SHEET

(71) Applicant: Nitto Denko Corporation, Osaka (JP)

(72) Inventors: Toshiki Ikami, Ibaraki-shi (JP); Yasushi Buzojima, Ibaraki-shi (JP); Kenta Jozuka, Ibaraki-shi (JP); Naoaki Higuchi, Ibaraki-shi (JP); Midori Segawa, Ibaraki-shi (JP); Naohiro Kato, Ibaraki-shi (JP)

(73) Assignee: Nitto Denko Corporation, Osaka (JP)

(21) Appl. No.: 16/682,005

(22) Filed: Nov. 13, 2019

(30) Foreign Application Priority Data
Nov. 14, 2018 (JP) 2018-213778

(51) Int. Cl. C09J 7/38; C09J 133/08; B32B 27/06

(52) U.S. Cl. CPC C09J 7/38; C09J 133/08; C09J 2467/00; C09J 2463/001; B32B 27/065

(57) ABSTRACT

Provided is a PSA sheet capable of providing reliable adhesion even upon exposure to cosmetics, chemicals and the like containing polar compounds. The PSA sheet provided by this invention has a PSA layer comprising a polyester-based polymer. The PSA sheet has a 180° peel strength of 1 N/5 mm or greater after ethanol immersion.

### CROSS-REFERENCE

This application claims priority to Japanese Patent Application No. 2018-213778 filed on Nov. 14, 2018 and the entire content thereof is incorporated herein by reference.

### BACKGROUND OF THE INVENTION

### 1. Field of the Invention

The present invention relates to a portable electronic device and pressure-sensitive adhesive sheet.

### 2. Description of the Related Art

In general, pressure-sensitive adhesive (PSA) exists as a soft solid (a viscoelastic material) in a room temperature range and has a property to adhere easily to an adherend with some pressure applied. With such properties, PSA is widely used, for instance, as a substrate-supported PSA sheet having a PSA layer on a support substrate or as a substrate-free PSA sheet, for purposes such as bonding, fastening and protecting components in mobile phones and other portable devices. Technical documents related to PSA tapes used in portable electronics include Japanese Patent Application Publication Nos. 2009-215355 and 2013-100485. In these documents, acrylic PSA is used as the PSA. Conventional art documents related to polyester-based PSA include Japanese Patent Application Publication Nos. 2017-115149 and 2015-134906.

### SUMMARY OF THE INVENTION

Portable devices are carried around for use and thus are susceptible to accumulation of oil from foods, skin secretion such as sebum and hand oils, and chemicals such as cosmetics, hair styling products, moisturizing cream, and sunscreens. Especially, portable touch-panel devices that have recently gained significant popularity often accumulate oil via fingertips because they have screens (display/input members) serving as both displays (outputs) and input devices and surfaces of the screens are directly touched by user's fingertips for operation. Some so-called wearable devices are worn directly on the skin and are often exposed to oil such as sebum and chemicals put on the skin. For instance, in such an application, when the PSA layer of a PSA sheet fastening a component is touched with such oil (sebum, cosmetics, etc.), undesired conditions may result such as a decrease in adhesive strength and exudation of the PSA. With respect to these issues, for instance, in Japanese Patent Application Publication No. 2009-215355, studies have been conducted on acrylic PSA sheets that are less susceptible to softening and swelling of PSA upon oil penetration as well as to exudation of the PSA when used to fix a component.

Lately, higher levels of chemical resistance tend to be required of PSA sheets used in portable devices. In particular, portable devices may be touched not only with the oil described above, but also with perfumes, insect repellents, hand wash detergents, antibacterial wipes and the like through, for instance, manual operations. Many of these cosmetics, chemicals and the like include alcohol (typically ethanol) as the solvent or dispersion medium. With respect to acrylic PSA as those described in Japanese Patent Application Publication Nos. 2009-215355 and 2013-100485, however, it is difficult to obtain resistance to polar solvents such as alcohols. This is because, in the acrylic PSA, oil resistance is improved more or less through the PSAs polarity (e.g. a polar functional group added to the base polymer or tackifier resin, etc.). As for non-acrylic PSA, while rubber-based PSA and urethane-based PSA can be possibilities, it is not easy with either possibility to obtain good resistance to both low-polar and polar compounds. In addition, as compared to the acrylic PSA, it is also difficult to obtain comparable adhesive properties (e.g. peel strength and holding power).

Under such circumstances, the present inventors have found that a polyester-based PSA is capable of exhibiting good resistance to both low-polar and polar compounds, and further studies have led to completion of the present invention. In other words, an objective of the present invention is to provide a PSA sheet capable of providing reliable adhesion even when exposed to cosmetics, chemicals and the like including polar compounds.

The present description provides a PSA sheet having a PSA layer that includes a polyester-based polymer. The PSA sheet has a 180° peel strength of 1 N/5 mm or greater after ethanol immersion. The PSA sheet uses a polyester-based polymer-containing PSA as the PSA; and therefore, unlike acrylic PSA, it can show excellent resistance to both low-polar and polar compounds. Because the PSA sheet shows a post-ethanol-immersion peel strength of at least the prescribed value, it can also provide reliable adhesion even when exposed to cosmetics, chemicals and the like that include polar compounds such as ethanol (or “polar chemicals” hereinafter). This feature can be particularly significant for its use in portable devices which are likely to be touched with oil (low-polar compounds) such as sebum, cosmetics and sunblock cream while potentially exposed as well to perfumes, insect repellents, hand wash detergents, antibacterial wipes and the like that include polar solvents (typically ethanol).

The PSA sheet according to a preferable embodiment has at least 50% retention of bonding strength after ethanol immersion. The PSA sheet satisfying this property can stably provide reliable adhesion even when touched with polar chemicals.

The PSA sheet according to a preferable embodiment has a 180° peel strength of 2 N/5 mm or greater after oleic acid immersion. The PSA sheet satisfying this property does not suffer a loss of adhesion reliability even when exposed to low-polar compounds such as oil. In other words, it has excellent resistance to the low-polar compounds. According to the art disclosed herein, in an embodiment having resistance to low-polar compounds, the adhesion reliability upon contact with polar chemicals can be improved. This has not been achieved with conventional acrylic PSA and is particularly significant for practical use.

The PSA sheet according to a preferable embodiment shows a displacement of 0.5 mm or less in a shear holding power test carried out with a load of 1 kg at a temperature of 60° C. for one hour. The PSA sheet satisfying this property has excellent holding power as well; and therefore, it can be preferably used for various purposes that require holding power. According to the art disclosed herein, in an embodiment having excellent holding power, the adhesion reliability upon contact with polar chemicals can be improved. This has not been achieved with conventional acrylic PSA and is particularly significant for practical use.

The PSA sheet according to a preferable embodiment has an initial 180° peel strength of 10 N/25 mm or greater. The PSA sheet satisfying this property can show sufficient bonding strength to an adherend.

In a preferable embodiment of the PSA sheet disclosed herein, the PSA layer comprises less than 80 parts by weight of a tackifier resin to 100 parts by weight of the polyester-based polymer. With the use of tackifier resin limited to less than the prescribed amount, it can preferably provide reliable adhesion even upon contact with polar chemicals and the adhesive properties can also be preferably improved, including the peel strength after oleic acid immersion and holding power.

In a preferable embodiment of the PSA sheet disclosed herein, the tackifier resin comprises a tackifier resin having a hydroxyl value of 30 mgKOH/g or higher. The tackifier resin whose hydroxyl value is at or above the prescribed value blends well with the polyester-based polymer and can preferably satisfy desirable properties.

In a preferable embodiment of the PSA sheet disclosed herein, the polyester-based polymer is crosslinked with a crosslinking agent. When the polymer in the PSA layer is so structured with the crosslinking agent, permeation of oil, polar solvents and the like are likely to be blocked. In the polyester-based polymer crosslinked with the crosslinking agent, the cohesive strength will increase and the holding power may preferably improve as well. The PSA layer according to a preferable embodiment has a gel fraction of 20% by weight or higher.

The PSA sheet disclosed herein can be preferably used for attaching a component of a portable electronic device. As described earlier, portable electronic devices are often touched with oil such as sebum and may be touched with polar chemicals as well. Thus, it is particularly significant to apply the art disclosed herein to make it resistant not only to low-polar compounds such as oil, but also to polar chemicals.

### BRIEF DESCRIPTION OF THE DRAWINGS

FIG. 1 shows a cross-sectional diagram schematically illustrating a structural example of the PSA sheet.

FIG. 2 shows a cross-sectional diagram schematically illustrating another structural example of the PSA sheet.

FIG. 3 shows a cross-sectional diagram schematically illustrating another structural example of the PSA sheet.

FIG. 4 shows a cross-sectional diagram schematically illustrating another structural example of the PSA sheet.

FIG. 5 shows a cross-sectional diagram schematically illustrating another structural example of the PSA sheet.

FIG. 6 shows a cross-sectional diagram schematically illustrating another structural example of the PSA sheet.

### DETAILED DESCRIPTION OF THE INVENTION

Preferred embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

As used herein, the term “PSA” refers to, as described earlier, a material that exists as a soft solid (a viscoelastic material) in a room temperature range and has a property to adhere easily to an adherend with some pressure applied.

### <Constitution of PSA Sheet>

The PSA sheet disclosed herein can be a substrate-supported PSA sheet having a PSA layer on one or each face of a substrate (support) or a substrate-free PSA sheet in which the PSA layer is retained on a release liner. The concept of PSA sheet herein encompasses so-called PSA tapes, PSA labels, PSA films and the like. The PSA sheet disclosed herein may be in a rolled form or in a flat sheet form. The PSA sheet may be further processed into various forms.

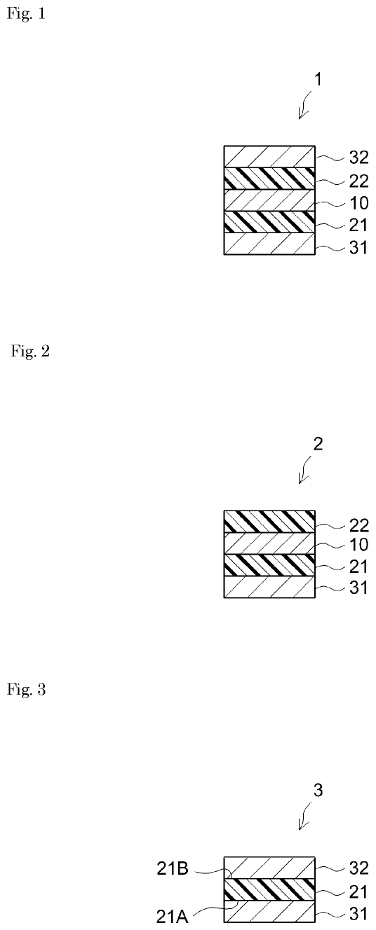

For instance, the PSA sheet disclosed herein may have cross-sectional structures as schematically illustrated in FIG. 1 to FIG. 6. Among these, FIG. 1 and FIG. 2 show structural examples of an adhesively double-faced substrate-supported PSA sheet. PSA sheet 1 shown in FIG. 1 has a structure in which PSA layers 21 and 22 are provided on the respective faces (both non-releasable) of substrate 10, protected with release liners 31 and 32 having releasable surfaces (release faces) at least on their PSA-facing sides, respectively. A PSA sheet 2 shown in FIG. 2 has a structure in which PSA layers 21 and 22 are provided on the respective faces (both non-releasable) of substrate 10, of which the first PSA layer 21 is protected with release liner 31 having a release face on each side. In a possible embodiment, such PSA sheet 2 can be wound so that the second PSA layer 22 comes in contact with the backside of release liner 31 to be also protected therewith.

FIG. 3 and FIG. 4 show structural examples of a substrate-free double-faced PSA sheet. PSA sheet 3 shown in FIG. 3 has a structure in which the respective faces 21A and 21B of a substrate-free PSA layer 21 are protected with release liners 31 and 32 having release faces at least on their PSA layer sides. PSA sheet 4 shown in FIG. 4 has a structure in which the first surface (adhesive face) 21A of substrate-free PSA layer 21 is protected with release liner 31 having a release face on each side. It can be wound so that the second surface (adhesive face) 21B of PSA layer 21 comes in contact with the backside of release liner 31 to be also protected therewith.

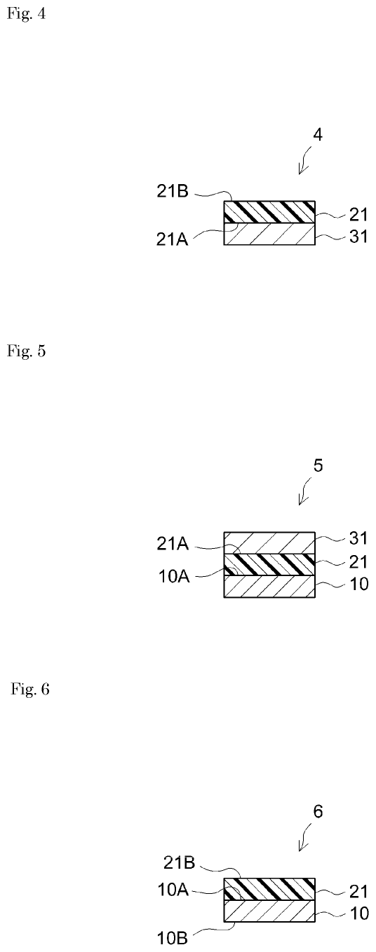

FIG. 5 and FIG. 6 show structural examples of an adhesively single-faced substrate-supported PSA sheet. PSA sheet 5 shown in FIG. 5 has a structure in which PSA layer 21 is provided on first face 10A (non-releasable) of substrate 10, with its surface (adhesive face) 21A protected with release liner 31 having a release face at least on the PSA layer side. PSA sheet 6 shown in FIG. 6 has a structure in which PSA layer 21 is provided on first face 10A (non-releasable) of substrate 10. Second face 10B of substrate 10 is a release face. When PSA sheet 6 is wound, second face 10B of the substrate comes in contact with PSA layer 21 to protect the surface (adhesive face) 21B thereof.

### <Properties of PSA Sheet>

The PSA sheet disclosed herein is characterized by having a 180° peel strength after ethanol immersion (post-ethanol-immersion peel strength) of 1 N/5 mm or greater. The PSA sheet satisfying this property can provide reliable adhesion even when exposed to polar chemicals and the like. The present inventors have learned that resistance to polar chemicals such as perfumes can be graded according to the post-ethanol-immersion peel strength and the effect of the post-ethanol-immersion peel strength is based on this particular knowledge. The post-ethanol-immersion peel strength is preferably about 1.4 N/5 mm or greater, more preferably about 1.7 N/5 mm or greater, yet more preferably about 2 N/5 mm or greater, or particularly preferably about 2.5 N/5 mm or greater (e.g. about 3 N/5 mm or greater). The maximum post-ethanol-immersion peel strength is not particularly limited. In practicality, it can also be about 8 N/5 mm or less (e.g. about 5 N/5 mm or less). The post-ethanol-immersion peel strength is determined by the method described later in Examples.

The PSA sheet disclosed herein preferably has a 180° peel strength after oleic acid immersion (post-oleic-acid-immersion peel strength) of about 2 N/5 mm or greater. The PSA sheet satisfying this property can provide reliable adhesion even when exposed to low-polar compounds such as oil. The post-oleic-acid-immersion peel strength is more preferably about 2.4 N/5 mm or greater, yet more preferably about 2.7 N/5 mm or greater, or particularly preferably about 3 N/5 mm or greater (e.g. about 4 N/5 mm or greater). The maximum post-oleic-acid-immersion peel strength is not particularly limited. In practicality, it can also be about 8 N/5 mm or less (e.g. about 5 N/5 mm or less). The post-oleic-acid-immersion peel strength is determined by the method described later in Examples.

The PSA sheet disclosed herein preferably has an initial 180° peel strength (initial peel strength) of about 10 N/25 mm or greater. Because the PSA sheet satisfying this property can show sufficient bonding strength to adherend, it can be preferably used for fastening and bonding. The initial peel strength is more preferably about 12 N/25 mm or greater (e.g. about 15 N/25 mm or greater). The maximum initial peel strength is not particularly limited. In practicality, it can also be about 30 N/25 mm or less (e.g. about 25 N/25 mm or less). The initial peel strength can be determined by the method described later in Examples. As in Examples described later, when the width of a PSA sheet used for the measurement is not 25 mm, the obtained peel strength value (N) can be divided by the width (mm) of the PSA sheet used and multiplied by 25 to obtain the peel strength in N/25 mm.

The PSA sheet disclosed herein preferably has at least about 50% retention of bonding strength after ethanol immersion, shown as the ratio of post-ethanol-immersion 180° peel strength S_{EtOH} to pre-ethanol-immersion 180° peel strength S0. The PSA sheet satisfying this property can consistently provide reliable adhesion even upon contact with polar chemicals. The retention of bonding strength after ethanol immersion is preferably about 60% or higher, more preferably about 70% or higher, yet more preferably about 80% or higher, or particularly preferably about 90% or higher. The % retention of bonding strength is determined by the equation S_{EtOH}/S0×100. The post-ethanol-immersion 180° peel strength S_{EtOH} is as described above and the pre-ethanol-immersion 180° peel strength S0 can be the initial 180° peel strength, but converted in N/5 mm.

The PSA sheet disclosed herein preferably has at least about 70% retention of bonding strength after oleic acid immersion, shown as the ratio of post-oleic-acid-immersion 180° peel strength S_{OA} to pre-oleic-acid-immersion 180° peel strength S0. The PSA sheet satisfying this property can consistently provide reliable adhesion even upon contact with low-polar compounds such as oil. The retention of bonding strength after oleic acid immersion is preferably about 80% or higher, more preferably about 90% or higher, or yet more preferably about 95% or higher (e.g. about 100% or higher). The % retention of bonding strength is determined by the equation S_{OA}/S0×100. The post-oleic-acid-immersion 180° peel strength S_{OA} is as described above and the pre-oleic-acid-immersion 180° peel strength S0 can be the initial 180° peel strength, but converted in N/5 mm.

The PSA sheet according to a preferable embodiment suitably shows a displacement of about 1 mm or less in a shear holding power test carried out with a load of 1 kg at a temperature of 60° C. for one hour. The PSA sheet satisfying this property has excellent holding power; and therefore, it can be preferably used for fastening and joining. The displacement in the shear holding power test is preferably about 0.5 mm or less, more preferably about 0.3 mm or less, yet more preferably about 0.2 mm or less, or particularly preferably about 0.1 mm or less. The shear holding power test is carried out by the method described later in Examples.

### <PSA Layer>

### (Polyester-Based Polymer)

The PSA sheet disclosed herein has a PSA layer formed with a PSA comprising a polyester-based polymer. The polyester-based polymer is typically included as the base polymer in the PSA layer. The “base polymer” of a PSA here refers to the primary component among the rubbery polymers (typically polymers that exhibit rubber elasticity in a room temperature range) in the PSA. As used herein, the “primary component” refers to a component accounting for more than 50% by weight of the content unless otherwise noted. As used herein, the polyester-based polymer refers to a polymer obtainable by polycondensation of a polycarboxylic acid (polyvalent carboxylic acid) and a polyol.

As the polycarboxylic acid used for synthesizing the polyester-based polymer, any species can be used among an aromatic polycarboxylic acid, an alicyclic polycarboxylic acid, an aliphatic polycarboxylic acid and an unsaturated polycarboxylic acid. Any can be used among a dicarboxylic acid containing two carboxy groups per molecule, a tricarboxylic acid (trivalent carboxylic acid) containing three carboxy groups, and a tetra- or higher polycarboxylic acid containing four or more carboxy groups.

Specific examples of the polycarboxylic acid include aromatic dicarboxylic acids such as isophthalic acid, terephthalic acid, orthophthalic acid, benzylmalonic acid, 2,2′-biphenyl dicarboxylic acid, 4,4′-biphenyl dicarboxylic acid, 4,4′-dicarboxydiphenyl ether, and naphthalene dicarboxylic acid; alicyclic dicarboxylic acids such as 1,2-cyclopentane dicarboxylic acid, 1,2-cyclohexane dicarboxylic acid, 1,3-cyclohexane dicarboxylic acid, 1,4-cyclohexane dicarboxylic acid, norbornane dicarboxylic acid, and adamantane dicarboxylic acid; aliphatic dicarboxylic acids such as malonic acid, succinic acid, glutaric acid, dimethyl glutaric acid, adipic acid, trimethyladipic acid, pimelic acid, suberic acid, azelaic acid, sebacic acid, thiopropionic acid, and diglycollic acid; unsaturated dicarboxylic acids such as maleic acid, maleic acid anhydride, fumaric acid, itaconic acid, and citraconic acid; tri- or higher polycarboxylic acids such as trimellitic acid, pyromellitic acid, adamantane tricarboxylic acid, and trimesic acid; dimeric acids and trimeric acids derived from aliphatic acids such as oleic acid; and derivatives of these. These can be used singly as one species or in a combination of two or more species. The derivatives of polycarboxylic acids include derivatives such as carboxylic acid salts, carboxylic acid anhydrides, halogenated carboxylic acids, and carboxylic acid esters.

As the polycarboxylic acid, an aromatic polycarboxylic acid (typically an aromatic dicarboxylic acid) is preferably used. With the use of aromatic polycarboxylic acid, permeation of polar chemicals tends to be readily prevented. In addition, the PSA's cohesive strength tends to increase with improved holding power. Favorable examples include isophthalic acid, terephthalic acid and orthophthalic acid. Isophthalic acid is more preferable. These can be used singly as one species or in a combination of two or more species. Examples include a combined use of isophthalic acid and terephthalic acid.

In the monomeric components of the polyester-based polymer, the molar ratio of the aromatic carboxylic acid in the polycarboxylic acid is not particularly limited. It is suitably about 1 mol % or higher. From the standpoint of the resistance to polar chemicals and the holding power, it is preferably about 10 mol % or higher, more preferably about 30 mol % or higher, yet more preferably about 40 mol % or higher, for instance, possibly about 50 mol % or higher, or even 60 mol % or higher. The molar ratio of the aromatic carboxylic acid is suitably about 95 mol % or lower. From the standpoint of the peel strength, etc., it is preferably about 85 mol % or lower, more preferably about 80 mol % or lower, or yet more preferably about 75 mol % or lower (e.g. 70 mol % or lower). The molar ratio of aromatic carboxylic acid can also be about 65 mol % or lower (e.g. about 55 mol % or lower).

As the polycarboxylic acid, an aliphatic polycarboxylic acid (typically an aliphatic dicarboxylic acid) is also preferable used. Favorable examples include dimethyl glutaric acid, adipic acid, trimethyladipic acid, pimelic acid, suberic acid, azelaic acid and sebacic acid. Among them, adipic acid, pimelic acid, suberic acid, azelaic acid and sebacic acid are more preferable; adipic acid and sebacic acid are yet more preferable.

In the monomeric components of the polyester-based polymer, the molar ratio of the aliphatic carboxylic acid in the polycarboxylic acid is not particularly limited. It is suitably about 1 mol % or higher. From the standpoint of the adhesive properties such as peel strength, it is preferably about 10 mol % or higher, more preferably about 15 mol % or higher, yet more preferably about 20 mol % or higher, or particularly preferably about 25 mol % or higher, or possibly even about 35 mol % or higher (e.g. about 50 mol % or higher). The molar ratio of the aliphatic carboxylic acid is suitably about 90 mol % or lower. From the standpoint of the resistance to polar chemicals, etc., it is preferably about 70 mol % or lower, more preferably about 60 mol % or lower, for instance, possibly about 50 mol % or lower, or even about 40 mol % or lower.

From the standpoint of obtaining a glass transition temperature (Tg) suited for PSA, it is preferable to use an aliphatic polycarboxylic acid (typically an aliphatic dicarboxylic acid) and an aromatic polycarboxylic acid (typically an aromatic dicarboxylic acid). The molar ratio of aliphatic polycarboxylic acid C_{A} to aromatic polycarboxylic acid C_{B}, C_{A}:C_{B}, is suitably about 1:49 to 49:1. It can be about 5:45 to 45:5. In a preferable embodiment, the molar ratio C_{A}:C_{B} is about 5:45 to 40:10, more preferably about 10:40 to 35:15 (e.g. about 15:35 to 30:20), for instance, possibly about 5:45 to 25:25, or even about 10:40 to 20:30 (e.g. about 15:35 to 20:30).

It is preferable that the polycarboxylic acid primarily comprises a dicarboxylic acid. One explanation is, but not particularly limited to, that the use of a tri- or higher polycarboxylic acid is likely to result in formation of a polar functional group in the polymer structure, providing a site through which polar chemicals can enter. From the standpoint of preventing permeation of polar chemicals, it may be desirable to form the main backbone with the dicarboxylic acid and inhibit the formation of polar functional group in the polymer structure. In addition, a tri- or higher polycarboxylic acid contributes to an increase in cohesive strength, thereby leading to lowered tightness of adhesion to adherend and possibly causing permeation of a polar solvent and the like via the adhesive interface. From such a standpoint, in the monomeric components of the polyester-based polymer, the ratio of dicarboxylic acid in the total amount of the polycarboxylic acid is suitably about 90 mol % or higher, preferably about 95 mol % or higher, more preferably about 98 mol % or higher, or yet more preferably about 99 mol % or higher (e.g. 99 mol % to 100 mol %), typically 99.9 mol % or higher (i.e. the polycarboxylic acid essentially consists of the dicarboxylic acid). The ratio of tri- or higher polycarboxylic acid in the total amount of the polycarboxylic acid is suitably about 10 mol % or lower, preferably about 5 mol % or lower, more preferably about 3 mol % or lower, yet more preferably about 1 mol % or lower, or particularly preferably about 0.1 mol % or lower (i.e. the polycarboxylic acid is essentially free of a tri- or higher polycarboxylic acid).

As the polyol used for synthesizing the polyester-based polymer disclosed herein, any species can be used among an aliphatic polyol, an alicyclic polyol, an aromatic polyol and an unsaturated polyol. Any can be used among a diol containing two hydroxy groups per molecule, a triol containing three hydroxy groups, and a tetra- or higher polyol containing four or more hydroxy groups.

Specific examples of the polyol include aliphatic diols such as ethylene glycol, diethylene glycol, triethylene glycol, propylene glycol, dipropylene glycol, 1,3-propane diol, 2-methyl1,3-propane diol, 2,2-dimethyl-1,3-propane diol, 2-ethyl-2-butyl-1,3-propane diol, 2-ethyl2-isobutyl-1,3-propane diol, 1,2-butane diol, 1,3-butane diol, 1,4-butane diol, 1,5-pantane diol, 3-methyl1,5-pantane diol, 1,6-hexane diol, 2-methyl1,3-hexane diol, 2,2,4-trimethyl1,6-hexane diol, and 1,8-octane diol; alicyclic diols such as 1,2-cyclohexane dimethanol, 1,3-cyclohexane dimethanol, 1,4-cyclohexane dimethanol, spyrro glycol, tricyclodecane dimethanol, adamantane diol, 2,2,4,4-tetramethyl1,3-cyclobutane diol; aromatic diols such as 4,4′-thiodiphenyl, 4,4′-methylene diphenyl, 4,4′-dihydroxybiphenyl, o-, m- and p-dihydroxybenzenes, 2,5-naphthalene diol, p-xylene diol and ethylene oxides of these, and propylene oxide adducts; dimeric diols; and tri- or higher polyols such as pentaerythritol, di pentaerythritol, tripentaerythritol, glycerin, trimethylol propane, trimethylol ethane, 1,3,6-hexane triol, and adamantane triol. These can be used singly as one species or in a combination of two or more species.

As the polyol, aliphatic polyols (typically aliphatic diols) and alicyclic polyols (typically alicyclic diols) are preferable. Aliphatic polyols are more preferable. A polyester-based polymer with excellent adhesive properties can be preferably obtained by synthesis combining a polyol (preferably an aliphatic diol) among these and an aforementioned polycarboxylic acid (preferably a polycarboxylic acid including an aromatic dicarboxylic acid). Favorable examples include ethylene glycol, propylene glycol, 1,3-propane diol, 2-methyl-1,3-propane diol, 2,2-dimethyl-1,3-propane diol (neopentyl glycol), 1,4-butane diol, 1,5-pantane diol, and 1,6-hexane diol. From the standpoint of the reactivity, etc., ethylene glycol, 1,3-propane diol, 2,2-dimethyl1,3-propane diol, 1,4-butane diol and 1,6-hexane diol are more preferable. These can be used singly as one species or in a combination of two or more species. Examples of the combination include a combination of ethylene glycol, 2,2-dimethyl-1,3-propane diol and 1,6-hexane diol.

In the monomeric components of the polyester-based polymer, the molar ratio of aliphatic and alicyclic polyols (preferably the molar ratio of aliphatic polyol(s)) in the polyol is not particularly limited. It is suitably about 50 mol % or higher. From the standpoint of obtaining good adhesive properties, it is preferably about 70 mol % or higher, more preferably about 80 mol % or higher, yet more preferably about 90 mol % or higher, or particularly preferably about 95 mol % or higher (e.g. 99 mol % to 100 mol %). The molar ratio of aliphatic and alicyclic polyols (preferably the molar ratio of aliphatic polyol(s)) can also be, for instance, 95 mol % or lower.

It is preferable that the polyol primarily comprises a diol. One explanation is, but not particularly limited to, that the use of a tri- or higher polyol is likely to lead to formation of a polar functional group (typically a hydroxy group) in the polymer structure, providing a site through which polar chemicals can enter. From the standpoint of preventing permeation of polar chemicals, it may be desirable to form the main backbone with the diol and inhibit the formation of polar functional group in the polymer structure. In addition, a tri- or higher polyol contributes to an increase in cohesive strength, thereby leading to lowered tightness of adhesion to adherend and possibly causing permeation of a polar solvent and the like via the adhesive interface. From such a standpoint, in the monomeric components of the polyester-based polymer, the ratio of diol in the total amount of the polyol is suitably about 90 mol % or higher, preferably about 95 mol % or higher, more preferably about 98 mol % or higher, or yet more preferably about 99 mol % or higher (e.g. 99 mol % to 100 mol %), typically 99.9 mol % or higher (i.e. the polyol essentially consists of the diol). The ratio of tri- or higher polyol in the total amount of the polyol is suitably about 10 mol % or lower, preferably about 5 mol % or lower, more preferably about 3 mol % or lower, yet more preferably about 1 mol % or lower, or particularly preferably about 0.1 mol % or lower (i.e. the polyol is essentially free of a tri- or higher polyol).

The polyester-based polymer can be essentially formed from the polycarboxylic acid and the polyol. However, for purposes such as introducing a desirable functional group and adjusting the molecular weight, as long as the effect of the art disclosed herein is not impaired, other comonomers (e.g. monovalent carboxylic acid and alcohol) can be copolymerized besides the polycarboxylic acid and the polyol. The ratio of the other comonomers is suitably, for instance, below about 3 mol %, typically below about 1 mol % (or even below 0.1 mol %). The art disclosed herein can be preferably implemented in an embodiment where the monomeric components of the polyester-based polymer are essentially free of such other comonomers.

The method for obtaining the polyester-based polymer disclosed herein is not particularly limited. A polymerization method known as a synthetic method of polyester-based polymer can be suitably employed. With respect to the starting monomers used for synthesizing the polyester-based polymer, from the standpoint of the polymerization efficiency, molecular weight adjustment, etc., it is suitable that at least one equivalent (e.g. one to two equivalents) of polyol is added to one equivalent of polycarboxylic acid. In a preferable embodiment, the amount of polyol added to one equivalent of polycarboxylic acid is more than one equivalent up to 1.8 equivalents (e.g. 1.2 to 1.7 equivalents).

The polyester-based polymer in the art disclosed herein can be obtained by polycondensation of a polycarboxylic acid and a polyol, similar to general polyesters. More specifically, the polyester-based polymer can be synthesized by carrying out the reaction between the carboxy group of the polycarboxylic acid and the hydroxy group of the polyol, in typical, while removing the water (byproduct water) formed in the reaction out of the reaction system. The byproduct water can be removed from the reaction system by a method where an inert gas is introduced into the reaction system to force the byproduct water out of the reaction system along with the inert gas, by a method (reduced pressure method) where the byproduct water is removed by evaporation from the reaction system under reduced pressure, or by like method. The reduced pressure method can be preferably employed as it is likely to reduce the time for synthesis and is suited for increasing the productivity.

The reaction temperature for carrying out the reaction (including esterification and polycondensation) as well as the extent of pressure reduction (the pressure inside the reaction system) when the reduced pressure method is employed can be suitably selected so as to efficiently obtain a polyester-based polymer with desired properties (e.g. molecular weight). While no particular limitations are imposed, the reaction temperature is usually suitably 180° C. to 260° C., for instance, 200° C. to 220° C. When the reaction temperature is in these ranges, a good reaction rate is obtained with increased productivity and degradation of the resulting polyester-based polymer is readily prevented or inhibited. While no particular limitations are imposed, the pressure inside is usually suitably 10 kPa or lower (typically 10 kPa to 0.1 kPa), for instance, possibly 4 kPa to 0.1 kPa. When the pressure inside the reaction system is in these ranges, the water formed in the reaction can be efficiently removed by evaporation from the system to maintain a good reaction rate. When the reaction temperature is relatively high, the pressure inside the reaction system is maintained at or above the lower limit to readily prevent elimination of the starting polycarboxylic acid and polyol by evaporation from the system. From the standpoint of stably maintaining the pressure inside the reaction system, the pressure inside the reaction system is usually suitably 0.1 kPa or higher.

In the reaction, similar to general polyester synthesis, a known or commonly-used catalyst can be used in a suitable amount for esterification and condensation. Examples of the catalyst include various metal compounds based on titanium, germanium, antimony, tin, zinc, etc.; and strong acids such as p-toluenesulfonic acid and sulfuric acid. Among them, the use of a titanium-based metallic compound (titanium compound) is preferable. Specific examples of the titanium compound include titanium tetraalkoxides such as titanium tetrabutoxide, titanium tetraisopropoxide, titanium tetrapropoxide and titanium tetraethoxide; alkyl titanates such as tetraisopropyl titanate, tetrabutyl titanate, octaalkyl trititanate and hexaalkyl dititanate; and titanium acetate.

A solvent may or may not be used in the process of synthesizing the polyester-based polymer by the reaction of polycarboxylic acid and polyol. The synthesis can be carried out, using essentially no organic solvent (e.g. it means to exclude an embodiment where an organic solvent is purposefully used as the reaction solvent during the reaction). It is preferable to synthesize the polyester-based polymer using essentially no organic solvent and prepare a polyester-based PSA using the polyester-based polymer because it matches the desire to reduce the use of organic solvents in the production process.

It is noted that there is a correlation between the molecular weight of the polyester-based polymer being synthesized and the viscosity of the reaction mixture; and therefore, during the reaction, this can be taken advantage of to manage the molecular weight of the polyester-based polymer. For instance, the stirrer's torque and the reaction mixture's viscosity can be continuously or intermittently measured (monitored) during the reaction to precisely synthesize a polyester-based polymer that meats the target molecular weight.

While no particular limitations are imposed, as the polyester-based polymer in the art disclosed herein, a polyester-based polymer having a hydroxyl value below 30 mgKOH/g (e.g. below 15 mgKOH/g) can be used. With the use of the polyester-based polymer having a hydroxyl value below the prescribed value, permeation of polar chemicals is readily blocked. The hydroxyl value of the polyester-based polymer is preferably below 12 mgKOH/g, more preferably below 10 mgKOH/g, for instance, possibly below 8 mgKOH/g or even below 5 mgKOH/g. The minimum hydroxyl value is 0 mgKOH/g or above (e.g. 1 mgKOH/g or above). The hydroxyl value of a polyester-based polymer can be determined based on JIS K0070:1992. The same method is also employed in Examples described later.

The acid value of the polyester-based polymer in the art disclosed herein is not particularly limited. For instance, a polyester-based polymer having an acid value below 10 mgKOH/g can be used. With the use of the polyester-based polymer having an acid value below the prescribed value, permeation of polar chemicals is readily blocked. The acid value of the polyester-based polymer is preferably below 5 mgKOH/g, more preferably below 3 mgKOH/g, or yet more preferably below 2 mg/KOH, for instance, possibly below 1 mgKOH/g. The minimum acid value is 0 mgKOH/g. The polyester-based polymer's acid value can be determined based on JIS K0070:1992. The same method is also employed in Examples described later.

While no particular limitations are imposed, from the standpoint of the tightness of adhesion to adherend, the polyester-based polymer has a Tg of advantageously about 15° C. or below, preferably about 0° C. or below, more preferably about −10° C. or below, or yet more preferably about −15° C. or below, for instance, possibly about −20° C. or below. From the standpoint of the cohesive strength of the PSA layer, the polyester-based polymer has a Tg of usually about −80° C. or above, preferably about −60° C. or above, more preferably aobut −40° C. or above, or yet more preferably about −30° C. or above (e.g. −20° C. or above). The Tg of the polyester-based polymer can be adjusted by suitably modifying the monomer composition (i.e. the species and ratio of monomers used in the synthesis of the polymer). In the art disclosed herein, as the base polymer of the PSA layer, any species can be used among a high Tg polyester-based polymer (e.g. having a Tg of −20° C. or above, typically between −20° C. and 15° C.), a medium Tg polyester-based polymer (e.g. having a Tg of −40° C. or higher below −20° C.) and a low Tg polyester-based polymer (e.g. having a Tg below −40° C., typically −80° C. or higher below −40° C. Among them, middle Tg and high Tg polyester-based polymers are preferable.

The polyester-based polymer's Tg can be determined using a commercially available differential scanning calorimeter (e.g. instrument name DSC Q20 available from TA Instruments). The measurement is taken while applying shear strain at a frequency of 1 Hz over a temperature range of −90° C. to 100° C. at a heating rate of 10° C./min. The same method is employed for the measurement in Examples described later.

The number average molecular weight (Mn) of the polyester-based polymer is not particularly limited. For instance, it can be about 5000 or higher. The Mn here refers to the value based on polystyrene standards determined by GPC (gel permeation chromatography). As the GPC system, for instance, a model name HLC-8320GPC (column: TSKgel GMH-H(S) available from Tosoh Corporation) can be used. From the standpoint of the resistance to polar chemicals, for instance, the cohesive strength, holding power, etc., the Mn of the polyester-based polymer is preferably about 7000 or higher, or more preferably about 9000 or higher; it can be, for instance, about 12000 or higher, about 15000 or higher, or even about 18000 or higher (e.g. about 24000 or higher). The Mn of the polyester-based polymer is usually suitably about 10×10⁴ or lower; for instance, from the standpoint of the adhesive strength, etc., it is preferably about 5×10⁴ or lower, more preferably about 3×10⁴ or lower; it can be, for instance, about 2×10⁴ or lower, or even about 1.5×10⁴ or lower.

### (Tackifier Resin)

As the tackifier resin, one, two or more species can be used, selected among various known tackifier resins such as phenolic resins, terpene-based resins, modified terpene-based resins, rosin-based resins, hydrocarbon-based tackifier resins, epoxy-based tackifier resins, polyamide-based tackifier resins, elastomer-based tackifier resins and ketone-based resins. The use of tackifier resin may improve the tightness of adhesion between the PSA layer and the adherend, effectively inhibiting permeation of oil and polar chemicals from the periphery of the PSA sheet into the adhesive interface.

Examples of the phenolic tackifier resin include terpene phenol resin, hydrogenated terpene phenol resin, alkylphenol resin and rosin-phenol resin.

The terpene phenol resin refers to a polymer comprising a terpene residue and a phenol residue, and its concept encompasses a copolymer of a terpene and a phenol compound (terpene phenol copolymer resin) as well as a phenol-modified terpene, terpene homopolymer or copolymer (phenol-modified terpene resin). Favorable examples of a terpene forming such a terpene phenol resin include monoterpenes such as α-pinene, ß-pinene, and limonene (including the D-isomer, L-isomer, and DL-limonene (dipentene)). The hydrogenated terpene phenol resin refers to a hydrogenated terpene phenol resin having a structure of such a terpene phenol resin with added hydrogen atoms. It is sometimes called hydrogenated terpene phenol resin.

The alkylphenol resin is a resin (oil-based phenol resin) obtainable from an alkylphenol and formaldehyde. Examples of the alkylphenol resin include a novolac type and a resol type.

The rosin-phenol resin is typically a resin obtainable by phenol modification of a rosin or one of the various rosin derivatives listed above (including a rosin ester, an unsaturated fatty acid-modified rosin and an unsaturated fatty acid-modified rosin ester). Examples of the rosin-phenol resin include a rosin-phenol resin obtainable by acid catalyzed addition of a phenol to a rosin or one of the various rosin derivatives listed above, followed by thermal polymerization.

Among these phenolic tackifier resins, terpene phenol resins, hydrogenated terpene phenol resins and alkyl phenol resins are preferable; terpene phenol resins and hydrogenated terpene phenol resins are more preferable; in particular, terpene phenol resins are preferable.

Examples of the terpene-based tackifier resin include polymers of terpenes (typically monoterpenes) such as α-pinene, ß-pinene, D-limonene, L-limonene, and dipentene. It can be a homopolymer of one species of terpene or a copolymer of two or more species of terpene. Examples of the homopolymer of one species of terpene include α-pinene polymer, ß-pinene polymer, and dipentene polymer.

Examples of the modified terpene resin include resins obtainable by modifying the terpene resins. Specific examples include styrene-modified terpene resins, and hydrogenated terpene resins.

The concept of rosin-based tackifier resin here encompasses both a rosin and a rosin derivative resin. Examples of the rosin include unmodified rosins (raw rosins) such as gum rosin, wood rosin, tall-oil rosin, etc.; modified rosins obtainable from these unmodified rosins via modifications such as hydrogenation, disproportionation, and polymerization (hydrogenated rosins, disproportionated rosins, polymerized rosins, and other chemically-modified rosins, etc.).

The rosin derivative resin is typically a derivative of a rosin such as those listed above. The concept of rosin-based resin herein encompasses a derivative of an unmodified rosin and a derivative of a modified rosin (including a hydrogenated rosin, a disproportionated rosin, and a polymerized rosin). Examples include rosin esters such as an unmodified rosin ester which is an ester of an unmodified rosin and an alcohol, and a modified rosin ester which is an ester of a modified rosin and an alcohol; an unsaturated fatty acid-modified rosin obtainable by modifying a rosin with an unsaturated fatty acid; an unsaturated fatty acid-modified rosin ester obtainable by modifying a rosin ester with an unsaturated fatty acid; rosin alcohols obtainable by reduction of carboxyl groups in rosins or aforementioned various rosin derivatives (including rosin esters, unsaturated fatty acid-modified rosin, and an unsaturated fatty acid-modified rosin ester); and metal salts of rosins or aforementioned various rosin derivatives. Specific examples of the rosin ester include a methyl ester, triethylene glycol ester, glycerin ester or pentaerythritol ester, etc., of an unmodified rosin or a modified rosin (hydrogenated rosin, disproportionated rosin, polymerized rosin, etc.).

Examples of the hydrocarbon-based tackifier resin include various hydrocarbon-based resins such as aliphatic hydrocarbon resins, aromatic hydrocarbon resins, alicyclic hydrocarbon resins, aliphatic/aromatic petroleum resins (styrene-olefin-based copolymer, etc.), aliphatic/alicyclic petroleum resins, hydrogenated hydrocarbon resins, coumarone-based resins, and coumarone-indene-based resins.

The softening point of the tackifier resin is not particularly limited. From the standpoint of increasing the cohesive strength, in an embodiment, it is preferable to use a tackifier resin having a softening point (softening temperature) of about 80° C. or above (preferably about 100° C. or above). The art disclosed herein can be preferably implemented in an embodiment where the tackifier resin having such a softening point accounts for more than 50% by weight (more preferably more than 70% by weight, e.g. more than 90% by weight) of the total tackifier resin content of the PSA layer. For instance, a phenolic tackifier resin (a terpene phenol resin, etc.) having such a softening point can be preferably used. In a preferable embodiment, a terpene phenol resin having a softening point of about 135° C. or above (or even about 140° C. or above) can be used. The maximum softening point of the tackifier resin is not particularly limited. From the standpoint of the tightness of adhesion to the adherend, in an embodiment, it is preferable to use a tackifier resin having a softening point of about 200° C. or below (more preferably about 180° C. or below). The softening point of the tackifier resin can be determined based on the softening point test method (ring and ball method) specified in JIS K2207.

In a preferable embodiment, the tackifier resin comprises one, two or more species of phenolic tackifier resin (e.g. terpene phenol resin). Phenolic tackifier resins tend to have greater compatibility with polyester-based polymers as compared to other tackifier resins (e.g. rosin-based tackifier resins). In addition, they tend to have low affinity to low-polar compounds (typically oil). The art disclosed herein can be preferably implemented in an embodiment where, for instance, a terpene phenol resin accounts for about 25% by weight or more (more preferably about 30% by weight or more) of the total tackifier resin content. Of the total tackifier resin content, the terpene phenol resin may account for about 50% by weight or more, or even about 80% by weight or more (e.g. about 90% by weight or more). The terpene phenol resin may account for essentially all (e.g. about 95% or more and 100% or less by weight, or even about 99% or more and 100% or less by weight) of the tackifier resin.

While no particular limitations are imposed, as the tackifier resin in the art disclosed herein, a tackifier resin having a hydroxyl value below 30 mgKOH/g (e.g. below 20 mgKOH/g) can be used. Hereinafter, a tackifier resin having a hydroxyl value below 30 mgKOH/g may be referred to as a “low-OH resin.” The hydroxyl value of the low-OH resin can also be about 15 mgKOH/g or lower, or even about 10 mgKOH/g or lower. The minimum hydroxyl value of the low-OH resin is not particularly limited. It can be essentially 0 mgKOH/g as well.

In a preferable embodiment, as the tackifier resin in the art disclosed herein, a tackifier resin having a hydroxyl value of 30 mgKOH/g or higher is used. Hereinafter, a tackifier resin having a hydroxyl value of 30 mgKOH/g or higher may be referred to as a “high-OH resin.” From the standpoint of the compatibility with the polyester-based polymer, resistance to low-polar compounds, etc., the hydroxyl value of the high-OH resin can be about 50 mgKOH/g or higher (e.g. about 60 mgKOH/g or higher). The maximum hydroxyl value of the high-OH resin is not particularly limited. From the standpoint of the compatibility with the polyester-based polymer, resistance to polar chemicals, etc., the hydroxyl value of the high-OH resin is usually suitably about 200 mgKOH/g or lower, preferably about 180 mgKOH/g or lower, more preferably about 160 mgKOH/g or lower, or yet more preferably about 140 mgKOH/g or lower.

Here, the hydroxyl value can be determined by the potentiometric titration method specified in JIS K0070:1992. Details of the method are described below.

### [Method for Measuring Hydroxyl Value]

### 1. Reagents

(1) As the acetylation reagent, is used a solution prepared by mixing with sufficient stirring about 12.5 g (approximately 11.8 mL) of anhydrous acetic acid and pyridine added up to a total volume of 50 mL. Alternatively, is used a solution prepared by mixing with sufficient stirring about 25 g (approximately 23.5 mL) of anhydrous acetic acid and pyridine up to a total volume of 100 mL.
(2) As the titrant, is used a 0.5 mol/L potassium hydroxide (KOH) solution in ethanol.
(3) For others, toluene, pyridine, ethanol and distilled water should be ready for use.

### 2. Procedures

(1) Approximately 2 g of analyte is accurately weighed out in a flat-bottom flask, 5 mL of the acetylation reagent and 10 mL of pyridine are added, and an air condenser is placed on.
(2) The flask is heated in a bath at 100° C. for 70 minutes and then cooled. From the top of the condenser, 35 mL of toluene is added as a solvent and stirred. Subsequently, 1 mL of distilled water is added and the resultant is stirred to decompose any remaining anhydrous acetic acid. The flask is heated in the bath again for 10 minutes to complete the decomposition and then cooled.
(3) After rinsed with 5 mL of ethanol, the condenser is removed. Subsequently, 50 mL of pyridine is added as a solvent and the resultant is stirred.
(4) Using a volumetric pipette, is added 25 mL of the 0.5 mol/L KOH ethanol solution.
(5) Potentiometric titration is carried out with the 0.5 mol/L KOH ethanol solution. The inflection point in the resulting titration curve is taken as the final point.
(6) For a blank titration, procedures (1) to (5) are carried out without addition of the analyte.

### 3. Calculations

The hydroxyl value is calculated by the following equation:

Hydroxyl value (mgKOH/g)=[(B−C)×f×28.05]/S+D

wherein:

B is the volume (mL) of the 0.5 mol/L KOH ethanol solution used in the blank titration;

C is the volume (mL) of the 0.5 mol/L KOH ethanol solution used to titrate the analyte;

f is the factor of the 0.5 mol/L KOH ethanol solution;

S is the weight of analyte (g);

D is the acid value;

28.05 is one half the molecular weight (56.11) of KOH.

As the low-OH resin and high-OH resin, species having corresponding hydroxyl values can be used among the various tackifier resins referred to above. With respect to the low-OH resin and high-OH resin, solely one species or a combination of two or more species can be used for each. For instance, as the low-OH resin, a phenolic tackifier resin having a hydroxyl value below 30 mgKOH/g can be used. As for the high-OH resin, for instance, a phenolic tackifier resin having a hydroxyl value of 30 mgKOH/g or greater can be preferably used. In particular, terpene phenol resins are preferable. Terpene phenol resins are convenient as their hydroxyl values can be arbitrarily controlled through the phenol's copolymerization ratio.

In an embodiment using a tackifier resin, the amount of tackifier resin included is not particularly limited. To 100 parts by weight of the polyester-based polymer, the tackifier resin content can be, for instance, greater than 0 part by weight, or about 3 parts by weight or greater (e.g. about 5 parts by weight or greater). The maximum tackifier resin content is not particularly limited. From the standpoint of the compatibility with the polyester-based polymer and the adhesiveness, in an embodiment, the tackifier resin content to 100 parts by weight of the polyester-based polymer is suitably about 120 parts by weight or less, preferably less than 80 parts by weight, or more preferably about 70 parts by weight or less (e.g. about 50 parts by weight or less). In another preferable embodiment, the tackifier resin content to 100 parts by weight of the polyester-based polymer is suitably less than 20 parts by weight (typically less than 15 parts by weight, e.g. less than 10 parts by weight).

In the art disclosed herein, in an embodiment using a high Tg polyester-based polymer (e.g. having a Tg of −20° C. or higher, typically between −20° C. and 15° C.) as the base polymer, the tackifier resin content to 100 parts by weight of the polyester-based polymer is suitably about 0 part by weight or greater (typically greater than 0 part by weight), preferably about 1 part by weight or greater, more preferably about 3 parts by weight or greater. It is suitably less than 10 parts by weight, preferably about 8 parts by weight or less, or more preferably about 6 parts by weight or less. In an embodiment using a middle Tg polyester-based polymer (e.g. having a Tg of −40° C. or higher below −20° C.) as the base polymer, the tackifier resin content to 100 parts by weight of the polyester-based polymer is suitably about 5 parts by weight or greater, preferably about 10 parts by weight or greater, or more preferably about 13 parts by weight or greater, for instance, possibly about 20 parts by weight or greater, or even 25 parts by weight or greater. In this embodiment, the tackifier resin content to 100 parts by weight of the polyester-based polymer is suitably less than 50 parts by weight, preferably less than 40 parts by weight, or more preferably about 35 parts by weight or less. In an embodiment using a low Tg polyester-based polymer (e.g. having a Tg below −40° C., typically −80° C. or higher below −40° C.) as the base polymer, the tackifier resin content to 100 parts by weight of the polyester-based polymer is about 10 parts by weight or greater, preferably about 20 parts by weight or greater, more preferably about 30 parts by weight or greater, or yet more preferably about 35 parts by weight or greater (e.g. about 50 parts by weight or greater). It is suitably less than 80 parts by weight or preferably about 70 parts by weight or less (e.g. about 65 parts by weight or less).

### (Crosslinking Agent)

The PSA composition used for forming the PSA layer preferably comprises a crosslinking agent as an optional component. The PSA layer in the art disclosed herein may comprise the crosslinking agent in a crosslinked form, in a non-crosslinked form, in a partially crosslinked form, in an intermediate or composite form of these, etc. The crosslinking agent in the PSA layer is usually in a crosslinked form. It is noted that the crosslinking agent used to crosslink the polyester-based polymer may also serve as a chain extender.

The type of crosslinking agent is not particularly limited. A suitable species can be selected and used among heretofore known crosslinking agents. Examples of such crosslinking agents include isocyanate-based crosslinking agents, epoxy-based crosslinking agents, oxazoline-based crosslinking agents, aziridine-based crosslinking agents, melamine-based crosslinking agents, and metal chelate-based crosslinking agents. For the crosslinking agent, solely one species or a combination of two or more species can be used. In particular, isocyanate-based crosslinking agents are preferable.

As the isocyanate-based crosslinking agent, a polyfunctional isocyanate (which refers to a compound having an average of two or more isocyanate groups per molecule, including a compound having an isocyanurate structure) can be preferably used. For the isocyanate-based crosslinking agent, solely one species or a combination of two or more species can be used.

Examples of the polyfunctional isocyanate include aliphatic polyisocyanates, alicyclic polyisocyanates, and aromatic polyisocyanates.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-1,5-pentane diisocyanate, 3-methyl-1,5-pentane diisocyanate, and lysine diisocyanate.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, and 4,4′-dicyclohexylmethane diisocyanate.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′ diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

A preferable example of the polyfunctional isocyanate has an average of three or more isocyanate groups per molecule. Such a tri-functional or higher polyfunctional isocyanate can be a multimer (e.g. a dimer or a trimer), a derivative (e.g., an addition product of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, and polyester polyisocyanate. Commercial polyfunctional isocyanates include trade name DURANATE TPA-100 available from Asahi Kasei Chemicals Corporation and trade names CORONATE L, CORONATE HL, CORONATE HK, CORONATE HX, and CORONATE 2096 available from Tosoh Corporation.

In an embodiment using an isocyanate-based crosslinking agent, the amount used is not particularly limited. To 100 parts by weight of the polyester-based polymer, the isocyanate-based crosslinking agent can be used in an amount of, for instance, about 0.5 part by weight or greater and about 10 parts by weight or less. From the standpoint of the resistance to polar chemicals, the amount of the isocyanate-based crosslinking agent used to 100 parts by weight of the polyester-based polymer is usually suitably about 1 part by weight or greater, or preferably about 1.5 parts by weight or greater (e.g. about 3 parts by weight or greater). The amount of the isocyanate-based crosslinking agent used to 100 parts by weight of the polyester-based polymer is usually suitably about 8 parts by weight or less, or preferably about 5 parts by weight or less.

The total amount of the crosslinking agent used is not particularly limited. For instance, to 100 parts by weight of the base polymer, it can be selected from a range of about 0.005 part by weight or greater (e.g. 0.01 part by weight or greater, typically 0.1 part by weight or greater) to about 10 parts by weight or less (e.g. about 8 parts by weight or less, preferably about 5 parts by weight or less).

### (Other Additives)

Besides the respective components described above, the PSA composition may comprise, as necessary, various additives generally used in the field of PSA, such as leveling agent, crosslinking co-agent, fillers, plasticizer, softening agent, anti-static agent, anti-aging agent, UV absorber, anti-oxidant, and photo-stabilizer. The polyester-based PSA composition disclosed herein may include a suitable amount of an anti-hydrolysis agent such as a carbodiimide or can be essentially free of such an agent. Here, that a PSA composition is essentially free of an anti-hydrolysis agent means that the anti-hydrolysis agent content in the PSA composition is below 0.01% by weight (e.g. below 0.003% by weight). With respect to these various additives, heretofore known species can be used by typical methods. Because they do not particularly characterize this invention, details are omitted.

The PSA layer disclosed herein can be formed by a heretofore known method. For instance, it is possible to employ a direct method where the PSA composition is directly provided (typically applied) to a non-releasable substrate and allowed to dry to form a PSA layer. Alternatively, it is possible to employ a transfer method where the PSA composition is provided to a releasable surface (release face) and allowed to dry to form a PSA layer on the surface and the PSA layer is transferred to a non-releasable substrate. From the standpoint of the productivity, the transfer method is preferable. In a substrate-free embodiment, the PSA layer can be formed by applying the PSA composition to a releasable surface (release face), allowing it to dry and covering it with a release liner if necessary. As the release face, the surface of a release liner, a substrate's backside treated with a release agent, and like surface can be used. The PSA layer disclosed herein is not limited to, but typically formed in a continuous form. For instance, the PSA layer may be formed in a regular or random pattern of stripes, etc.

The PSA composition can be applied with a heretofore known coater, for instance, a gravure roll coater, die coater, and bar coater. Alternatively, the PSA composition can be applied by immersion, curtain coating, etc.

The PSA composition can be dried at room temperature or by heating it. From the standpoint of facilitating the crosslinking reaction, increasing the production efficiency, etc., the PSA composition is dried preferably with heating. The drying temperature can be, for instance, about 40° C. to 150° C.; it is usually preferably about 40° C. to 100° C. After the PSA composition is dried, it is preferably subjected to aging for purposes such as adjusting migration of the components in the PSA layer, accelerating the crosslinking reaction, and releasing the distortion that may be present in the substrate and the PSA layer. The conditions for aging are not particularly limited. For instance, it can be at or below about 70° C. (typically about 40° C. to 70° C.) for at least one day (e.g. three days or more).

The thickness of the PSA layer is not particularly limited. From the standpoint of avoiding too thick a PSA sheet, the PSA layer's thickness is usually suitably about 100 μm or less, preferably about 70 μm or less, more preferably about 50 μm or less, or yet more preferably about 30 μm or less. In general, with decreasing thickness of the PSA layer, the tightness of adhesion to adherend decreases and permeation of polar chemicals and oil via the interface with the adherend tends to easily occur. Accordingly, it is particularly significant to apply the art disclosed herein. In the PSA sheet according to a preferable embodiment, the PSA layer has a thickness of about 25 μm or less (usually less than 25 μm, more preferably about 22 μm or less, e.g. about 20 μm or less). The minimum thickness of the PSA layer is not particularly limited. From the standpoint of the tightness of adhesion to adherend, it is advantageously about 4 μm or greater, preferably about 6 μm or greater, or more preferably about 10 μm or greater (e.g. about 15 μm or greater).

### (Tg of PSA Layer)

From the standpoint of preferably obtaining the effect of the art disclosed herein, it is preferable that the PSA layer in the art disclosed herein has a Tg in a certain range, determined from the Tg of the polyester-based polymer in the PSA layer and the softening point of a tackifier resin, if any, included as an optional component. The PSA layer has a Tg of preferably about −35° C. or above, more preferably about −30° C. or higher, yet more preferably about −25° C. or above, or particularly preferably about −20° C. or above, for instance, possibly about −15° C. or higher, or even about −12° C. or above. The PSA layer may have a Tg of preferably about 10° C. or below, more preferably about 0° C. or below, or yet more preferably about −5° C. or below, for instance, possibly about −10° C. or below.

The PSA layer's Tg is determined by the Fox equation, taking the polyester-based polymer's Tg and the tackifier resin's softening point as the Tg values of the respective components. In particular, it is determined by the next equation:

1/Tg(PSA)=[(W(p)/Tg(p))+(W(t)/Tg(t))]

In the equation, Tg(PSA) is the glass transition temperatures (in K) of the PSA layer (essentially formed of the polyester-based polymer and tackifier resin as primary components); W(p) is the weight fraction of the polyester-based polymer relative to the total amount of the polyester-based polymer and tackifier resin in the PSA layer; Tg(p) is the glass transition temperatures (in K) of the polyester-based polymer; W(t) is the weight fraction of the tackifier resin relative to the total amount of the polyester-based polymer and tackifier resin in the PSA layer; Tg(t) is the softening point (in K) of the tackifier resin.

### (Gel Fraction)

While no particular limitations are imposed, the PSA layer disclosed herein can have a gel fraction (by weight) of, for instance, 20% or higher; it is usually suitably 30% or higher, preferably 35% or higher, or more preferably 40% or higher (e.g. 45% or higher). With increasing gel fraction of the PSA layer in a suitable range, permeation of polar chemicals is readily prevented. The holding power tends to increase as well. On the other hand, the gel fraction can be adjusted to be at or below a certain value to enhance the tightness of adhesion to adherend and prevent permeation of polar chemicals. From such a standpoint, the gel fraction of the PSA layer is preferably 90% or lower, more preferably 80% or lower, or yet more preferably 70% or lower (e.g. 65% or lower).

Here, the “gel fraction of a PSA layer” refers to the value determined by the method described below. The gel fraction can be thought as the weight ratio of the ethyl acetate-insoluble content of the PSA layer.

### [Method for Determining Gel Fraction]

A PSA sample (weight: W_{g1}) weighing approximately 0.1 g is wrapped into a pouch with a porous polytetrafluoroethylene membrane (weight: Wg₂), and the opening is tied with twine (weight: Wg₃). As the porous polytetrafluoroethylene (PTFE) membrane, product name NITOFLON® NTF1122 (0.2 μm mean pore diameter, 75% porosity, 85 μm thick) available from Nitto Denko Corporation or an equivalent product is used.

The resulting pouch is immersed in 50 mL of ethyl acetate and stored at room temperature (typically 23° C.) for 7 days to extract the sol fraction of the PSA layer out of the membrane. Subsequently, the pouch is collected, and any residual ethyl acetate is wiped off the outer surface. The pouch is dried at 130° C. for 2 hours and the pouch's weight (Wg₄) is determined. The gel fraction F_{G} of the PSA layer is determined by substituting the respective values into the equation shown below. The same method is used in the working examples described later.

Gel Fraction F_{G} (%)=[(Wg₄−Wg₂−Wg₃)/Wg₁]×100

### <Substrate>

In an embodiment where the PSA sheet disclosed herein is an adhesively single-faced or double-faced substrate-supported PSA sheet, as the substrate to support (back) the PSA layer, resin film, paper, fabric, a rubber sheet, a foam sheet, metal foil, a composite of these and the like can be used. Examples of resin film include polyolefin films such as polyethylene (PE), polypropylene (PP), and ethylene-propylene copolymer; polyester films such as polyethylene terephthalate (PET); polyvinyl chloride resin films; vinyl acetate resin films; polyimide resin films; polyamide resin films; fluororesin films; and cellophane. Examples of paper include Japanese paper, Kraft paper, glassine paper, high-grade paper, synthetic paper, and top-coated paper. Examples of fabrics include woven fabric and nonwoven fabric of pure or blended yarn of various fibrous materials. Examples of fibrous materials include cotton, staple cloth, Manila hemp, pulp, rayon, acetate fiber, polyester fiber, polyvinyl alcohol fiber, polyamide fiber, and polyolefin fiber. Examples of rubber sheets include natural rubber sheets and butyl rubber sheets. Examples of foam sheets include polyurethane foam sheets and polychloroprene rubber foam sheets. Examples of metal foil include aluminum foil and copper foil.

The concept of non-woven fabric as used herein primarily refers to non-woven fabric for PSA sheets used in the field of PSA tapes and other PSA sheets, typically referring to non-woven fabric (or so-called “paper”) fabricated using a general paper machine. The resin film referred to here is typically a non-porous resin sheet and its concept is distinct from, for instance, non-woven fabric (i.e. it excludes non-woven fabric). The resin film may be any among non-stretched film, uniaxially stretched film and biaxially stretched film. The surface of the substrate to which a PSA layer is provided may be subjected to a surface treatment such as primer coating, corona discharge treatment, and plasma treatment.

The art disclosed herein can be preferably implemented in an embodiment of a substrate-supported PSA sheet having the PSA layer on at least one face of the substrate (support). For instance, it can be made in an embodiment of a substrate-supported double-faced PSA sheet having the PSA layer on each of the two faces of substrate film.

A preferable substrate film comprises a resin film as the base film. The base film is typically capable of maintaining the shape by itself (self-standing). The substrate film in the art disclosed herein may be essentially formed of such a base film. Alternatively, the substrate film may include a supplemental layer in addition to the base film Examples of the supplemental layer include a primer layer, an anti-static layer and a colored layer formed on the surface of the base film.

The resin film comprises a resin material as the primary component (a component accounting for more than 50% by weight of the resin film) Examples of the resin film include polyolefinic resin films such as polyethylene (PE), polypropylene (PP), and ethylene-propylene copolymer; polyester-based resin films such as polyethylene terephthalate (PET), polybutylene terephthalate (PBT), and polyethylene naphthalate (PEN); vinyl chloride-based resin film; vinyl acetate-based resin film; polyimide-based resin film; polyamide-based resin film; fluororesin film; and cellophane. The resin film can also be a rubber-based film such as natural rubber film and butyl rubber film. In particular, from the standpoint of the handling properties and the ease of processing, polyester films are preferable and among them PET film is particularly preferable. As used herein, the “resin film” typically refers to a non-porous sheet and should be conceptually distinguished from so-called non-woven and woven fabrics (i.e. the concept excludes non-woven and woven fabrics).

To the resin film (e g PET film), various additives can be added as necessary, such as fillers (inorganic and organic fillers, etc.), colorant, dispersing agent (surfactant, etc.), anti-aging agent, antioxidant, UV absorber, anti-static agent, slip agent and plasticizer. The total amount of various additives is usually less than about 30% by weight (e.g. less than about 20% by weight, preferably less than about 10% by weight).

The resin film may have a monolayer structure or a multilayer structure with two, three or more layers. From the standpoint of the shape stability, the resin film preferably has a monolayer structure. In case of a multilayer structure, at least one layer (preferably each layer) preferably has a continuous structure formed of the resin (e.g. a polyester-based resin). The method for producing the resin film is not particularly limited and a heretofore known method can be suitably employed. For instance, heretofore known general film-forming methods can be suitably employed, such as extrusion, inflation molding, T-die casting, and calender rolling.

The thickness of the substrate film disclosed herein is not particularly limited. From the standpoint of avoiding too thick a PSA sheet, the thickness of the substrate film can be, for instance, about 200 μm or less, preferably about 150 μm or less, or more preferably about 100 μm or less. According to the purpose and application of the PSA sheet, the substrate film can have a thickness of about 70 μm or less, about 50 μm or less, or even about 30 μm or less (e.g. about 25 μm or less). In an embodiment, the thickness of the substrate film can be about 20 μm or less, about 15 μm or less, or even about 10 μm or less (e.g. about 5 μm or less). With decreasing thickness of the substrate film, the thickness of the PSA layer can be increased even when the overall thickness of the PSA sheet is kept the same. This may be advantageous in view of increasing the tightness of adhesion to the substrate. The minimum thickness of the substrate film is not particularly limited. From the standpoint of the PSA sheet's handling properties and ease of processing, etc., the thickness of the substrate film is usually about 0.5 μm or greater (e.g. 1 μm or greater), or preferably about 2 μm or greater, for instance, about 4 μm or greater. In an embodiment, the thickness of the substrate film can be about 6 μm or greater, about 8 μm or greater, or even about 10 μm or greater (e.g. greater than 10 μm).

In an embodiment using a foam substrate as the substrate, the thickness of the foam substrate is not particularly limited. It can be suitably selected in accordance with the strength and flexibility of the double-faced PSA sheet and its purpose of use. From the standpoint of thinning the joint, the thickness of the foam substrate is usually suitably about 0.70 mm or less, preferably about 0.40 mm or less, or more preferably about 0.30 mm or less. From the standpoint of the ease of processing the PSA sheet to have a narrow width, the art disclosed herein can be preferably implemented in an embodiment where the thickness of the foam substrate is about 0.20 mm or less (typically 0.18 mm or less, e.g. 0.16 mm or less). From the standpoint of reducing the oil penetration into the adhesive interface, etc., the thickness of the foam substrate is suitably about 0.05 mm or greater, preferably about 0.06 mm or greater, or more preferably about 0.07 mm or greater (e.g. about 0.08 mm or greater). The art disclosed herein can be preferably implemented in an embodiment where the foam substrate has a thickness of about 0.10 mm or greater (typically greater than 0.10 mm, preferably 0.12 mm or greater, e.g. 0.13 mm or greater). With increasing thickness of the foam substrate, the impact resistance improves as well, whereby desirable impact resistance tends to be obtained even in an embodiment having a narrower width.

The surface (typically the PSA layer-side surface) of the substrate (e.g. a substrate film layer) can be subjected to heretofore known surface treatment such as corona discharge treatment, plasma treatment, UV irradiation, acid treatment, base treatment and undercoating. Such surface treatment may increase the tightness of adhesion between the substrate and the PSA layer, that is, the anchoring of the PSA layer to the substrate.

The thickness of the substrate can be suitably selected in accordance with the purpose and its type. It is generally about 2 μm or greater (e.g. 10 μm or greater, typically 20 μm or greater) and about 1000 μm or less (e.g. 500 μm or less, typically 200 μm or less).

### <Release Liner>

In the art disclosed herein, a release liner can be used in forming the PSA layer, fabricating the PSA sheet, and storing, distributing and shaping the PSA sheet before used, etc. The release liner is not particularly limited. Examples include a release liner having a release layer on a face of a release liner substrate such as resin film and paper as well as a release liner formed of a low-adhesive material such as fluoropolymer (polytetrafluoroethylene, etc.) and polyolefinic resin (polyethylene, polypropylene, etc.). The release layer may be formed by subjecting the liner substrate to surface treatment with a release agent such as silicone-based, long-chain alkyl and fluorine-based kinds, and molybdenum sulfide.

### <Overall Thickness of PSA Sheet>

The PSA sheet disclosed herein is not particularly limited in thickness (excluding release liners if any). The overall thickness of the PSA sheet can be, for instance, about 500 μm or less; it is usually suitably about 350 μm or less, or preferably about 250 μm or less (e.g. about 200 μm or less). The art disclosed herein can be preferably implemented in an embodiment of a PSA sheet having an overall thickness of about 150 μm or less (more preferably about 100 μm or less, or yet more preferably less than about 60 μm, e.g. about 55 μm or less). The PSA sheet according to an embodiment (e.g. a substrate-free PSA sheet) has an overall thickness of preferably about 50 μm or less, or more preferably about 30 μm or less. The minimum thickness of the PSA sheet is not particularly limited. From the standpoint of the tightness of adhesion to the adherend, it is advantageously about 4 μm or greater, preferably about 6 μm or greater, or more preferably about 10 μm or greater (e.g. about 15 μm or greater). The overall thickness of the PSA sheet (e.g. a substrate-supported PSA sheet) can be about 10 μm or greater, about 20 μm or greater, or even about 30 μm or greater.

### <Applications>

The PSA sheet disclosed herein can provide reliable adhesion even when exposed to polar chemicals. For this feature, the PSA sheet can be preferably used for fastening various parts that may be touched with oil. Typical examples of such an application include fixing components of various portable devices. For instance, it is suited for fixing a part in a portable electronic device. Non-limiting examples of portable electronics include smartphones, tablet PCs, notebook PCs, various wearable devices (e.g. wrist wears put on wrists such as wrist watches; modular devices attached to bodies with a clip, strap, etc.; eye wears including glass-shaped wears (monoscopic or stereoscopic, including head-mounted pieces); clothing types worn as, for instance, accessories on shirts, socks, hats/caps, etc.; ear wears such as earphones put on ears; etc.), digital cameras, digital video cameras, acoustic equipment (portable music players, IC recorders, etc.), calculators (e.g. pocket calculators), handheld game devices, electronic dictionaries, electronic notebooks, electronic books, vehicle navigation devices, portable radios, portable TVs, portable printers, portable scanners, and portable modems. Non-limiting examples of portable devices other than portable electronics include mechanical watch, pocket watch, pocket light, handheld mirror and pass case. As used herein, being “portable” means not just providing simple mobility, but further providing a level of portability that allows relatively easy carry by an individual (average adult).

The PSA sheet according to a particularly preferable embodiment is used for bonding and fixing components of portable electronics having touch panels. These portable electronics have display/input members (typically touch panels) serving as both displays (outputs) and input devices and the surfaces of the display/input members are directly touched by user's fingertips for operation; and they are susceptible to accumulation of low-polar compounds such as oil and the like from foods, the skin secretion such as sebum and hand oils, and chemicals such as cosmetics, hair styling products, moisturizing cream, and sunscreens. They can also be exposed to polar chemicals containing polar solvents (typically ethanol), such as perfumes, insect repellents, hand wash detergents and antibacterial wipes. With respect to portable electronic devices that are often touched with such low-polar compounds and polar chemicals, the effect of the PSA sheet disclosed herein may be preferably obtained.

The PSA sheet (typically a double-faced PSA sheet) disclosed herein can be processed into various shapes and used as a joint for fixing components of portable electronics. Particularly preferable applications include fixing components of portable electronics. In particular, it can be preferably used in portable electronics having liquid crystal displays (LCD). For instance, in such a portable electronic device, it is favorable to bond a case and a display (possibly a display of LCD) or a protective material for the display.

In a preferable embodiment, the joint has a narrow segment having a width of 4.0 mm or less (e.g. 2.0 mm or less, usually less than 2.0 mm) With the potentially great cohesive strength in addition to the oil resistance, the PSA sheet disclosed herein can fasten components well even when used as a joint having a shape (e.g. a frame shape) that includes such a narrow segment. In an embodiment, the narrow segment may have a width of 1.5 mm or less, 1.0 mm or less, or even about 0.5 mm or less. The minimum width of the narrow segment is not particularly limited. From the standpoint of the handling properties of the PSA sheet, it is usually suitably 0.1 mm or greater (e g 0.2 mm or greater).

The narrow segment is typically linear. Here, the concept of being linear encompasses shapes that are straight, curved, bent (e.g. L-shaped) and also ring-shaped (frame-shaped, circular, etc.) as well as their composite or intermediate shapes. The ring shape is not limited to a curved shape. The concept encompasses, for instance, a ring shape of which part or all is straight, such as a shape that conforms to the circumference of a square (i.e. a frame shape) and a shape that conforms to a sector shape. The narrow segment is not particularly limited in length. For instance, in an embodiment where the narrow segment has a length of 10 mm or greater (more preferably 20 mm or greater, e.g. 30 mm or greater), the effect of the art disclosed herein can be favorably obtained.

The matters disclosed by the present description include the following:

(1) A portable electronic device having a touch panel whose display also serves as an input device, wherein

the touch panel can be operated by direct finger touch,

the portable electronic device has components bonded together with a PSA sheet,

the PSA sheet has a PSA layer comprising a polyester-based polymer, and

the PSA sheet has a 180° peel strength of 1 N/5 mm or greater after ethanol immersion.

(2) The portable electronic device according to (1) above, that is a portable phone.
(3) The portable electronic device according to (1) above, that is a smartphone.
(4) The portable electronic device according to (1) above, that is a tablet PC.
(5) The portable electronic device according to (1) above, that is a wearable device.
(6) The portable electronic device according to (1) above, that is a digital camera.
(7) The portable electronic device according to (1) above, that is a portable music player.
(8) The portable electronic device according to (1) above, that is a portable game device.
(9) The portable electronic device according to (1) above, that is an electronic dictionary.
(10) The portable electronic device according to (1) above, that is an electronic book.
(11) A PSA sheet that has a PSA layer comprising a polyester-based polymer and has a 180° peel strength of 1N/5 mm or greater after ethanol immersion.
(12) The PSA sheet according to (11) above, having at least 50% retention of bonding strength after ethanol immersion.
(13) The PSA sheet according to (11) or (12) above, having a 180° peel strength of 2 N/5 mm or greater after oleic acid immersion.
(14) The PSA sheet according to any of (11) to (13) above, showing a displacement of 0.5 mm or less in a shear holding power test carried out with a load of 1 kg at a temperature of 60° C. for one hour.
(15) The PSA sheet according to any of (11) to (14) above, having an initial 180° peel strength of 10 N/25 mm or greater.
(16) The PSA sheet according to any of (11) to (15) above, wherein the PSA layer comprises less than 80 parts by weight of a tackifier resin to 100 parts by weight of the polyester-based polymer.
(17) The PSA sheet according to (16) above, wherein the tackifier resin comprises a tackifier resin having a hydroxyl value of 30 mgKOH/g or higher.
(18) The PSA sheet according to any of (11) to (17) above, wherein the polyester-based polymer is crosslinked with a crosslinking agent.
(19) The PSA sheet according to any of (11) to (18) above, wherein the PSA layer has a gel fraction of 20% by weight or higher.
(20) The PSA sheet according to any of (11) to (19) above, wherein the polyester-based polymer is a polycondensation product of a polycarboxylic acid and a polyol, the polycarboxylic acid comprising an aromatic dicarboxylic acid.
(21) The PSA sheet according to (20) above, wherein the aromatic dicarboxylic acid includes at least isophthalic acid or terephthalic acid.
(22) The PSA sheet according to any of (11) to (21) above, wherein the polyester-based polymer is a polycondensation product of a polycarboxylic acid and a polyol, the polycarboxylic acid comprising an aliphatic dicarboxylic acid.
(23) The PSA sheet according to (22) above, wherein the aliphatic dicarboxylic acid includes at least adipic acid or sebacic acid.
(24) The PSA sheet according to any of (11) to (23) above, wherein the polyester-based polymer is a polycondensation product of a polycarboxylic acid and a polyol, the polyol comprising an aliphatic diol.
(25) The PSA sheet according to (24) above, wherein the aliphatic diol is at least one species selected from the group consisting of ethylene glycol, 1,3-propane diol, 2,2-dimethyl-1,3-propane diol, 1,4-butane diol and 1,6-hexane diol.
(26) The PSA sheet according to any of (11) to (25) above, wherein the polyester-based polymer has a hydroxyl value below 12 mgKOH/g.
(27) The PSA sheet according to any of (11) to (26) above, wherein the polyester-based polymer has an acid value below 5 mgKOH/g.
(28) The PSA sheet according to any of (11) to (27) above, wherein the polyester-based polymer has a glass transition temperature of −50° C. or higher and 0° C. or lower.
(29) The PSA sheet according to any of (11) to (28) above, wherein the polyester-based polymer has a number average molecular weight of 7000 or higher and 5×10⁴ or lower.
(30) The PSA sheet according to any of (11) to (29) above, wherein the polyester-based polymer is crosslinked with a crosslinking agent, the crosslinking agent including an isocyanate-based crosslinking agent.
(31) The PSA sheet according to any of (11) to (30) above, wherein the PSA layer comprises a tackifier resin, at least 50% (by weight) of which being a phenolic tackifier resin (e.g. terpene-phenol resin).
(32) The PSA sheet according to any of (11) to (31) above, wherein the PSA layer comprises a tackifier resin, the tackifier resin having a softening point of 135° C. or higher.
(33) The PSA sheet according to any of (11) to (32) above, wherein the PSA layer has a glass transition temperature of −35° C. or higher and 10° C. or lower.
(34) The PSA sheet according to any of (11) to (33) above, wherein the PSA layer has a thickness of 10 μm or greater and 25 μm or less.
(35) The PSA sheet according to any of (11) to (34) above that is a substrate-free double-faced PSA sheet consisting of the PSA layer.
(36) The PSA sheet according to any of (11) to (34) above, formed as a substrate-supported PSA sheet having the PSA layer at least on one face of a substrate.
(37) The PSA sheet according to any of (11) to (36) above, used for fixing a component in a portable device.
(38) A portable device having the PSA sheet according to any of (11) to (36) above and components bonded together with the PSA sheet.

### EXAMPLES

Several working examples related to the present invention are described below, but the present invention is not to be limited to these examples. In the description below, “parts” and “%” are by weight unless otherwise specified.

### <<Evaluation Methods>>

### [Initial 180° Peel Strength]

In a measurement environment at 23° C. and 50% RH, one adhesive face of the double-faced PSA sheet is backed with 50 μm thick PET film applied thereto and cut into a 5 mm wide and 100 mm long size to obtain a PSA sheet specimen. In the same environment, the other face of the PSA sheet specimen is press-bonded to the surface of a stainless steel (SUS304BA) plate with a 2 kg roller moved back and forth once to prepare a measurement sample. The measurement sample is allowed to cure for 30 minutes in the same environment and is further left standing for 24 hours in the same environment. Subsequently, using a universal tensile/compression tester, based on JIS Z 0237:2000, the initial peel strength (N/5 mm) is determined at a tensile speed of 300 mm/min at a peel angle of 180°. As the universal tensile/compression tester, model name TG-1kN available from Minebea Co., Ltd. or a comparable product is used. For a single-faced PSA sheet, backing with PET film is not required.

### [Post-Ethanol-Immersion Peel Strength]

A measurement sample is obtained in the same manner as in the measurement of initial 180° peel strength and allowed to cure for 30 minutes in the same environment. Subsequently, in an environment at room temperature (23° C.), the measurement sample is immersed in ethanol in a container for 24 hours. Subsequently, the measurement sample is removed from the ethanol bath and residual ethanol on the sample is lightly wiped off with a dry cloth. The post-ethanol-immersion peel strength (N/5 mm) is then determined in the same manner as in the initial 180° peel strength measurement.

### [Post-Oleic-Acid-Immersion Peel Strength]

A measurement sample is obtained in the same manner as in the measurement of initial 180° peel strength and allowed to cure for 30 minutes in the same environment. Subsequently, in an environment at room temperature (23° C.), the measurement sample is immersed in oleic acid in a container for 24 hours. Subsequently, the measurement sample is removed from the oleic acid bath and residual oleic acid on the sample is lightly wiped off with a dry cloth. The post-oleic-acid-immersion peel strength (N/5 mm) is then determined in the same manner as in the initial 180° peel strength measurement.

### [Shear Holding Power]

Shear holding power is tested based on JIS Z 0237(2004). In an environment at 23° C. and 50% RH, one adhesive face of the double-faced PSA sheet is backed with 50 μm thick PET film applied thereto and cut 10 mm wide to prepare a measurement sample. The other adhesive face of the measurement sample is adhered to a Bakelite plate as the adherend over a 10 mm wide, 20 mm long bonding area. It is press-bonded with a 2 kg roller moved back and forth once. The measurement sample thus adhered to the adherend is vertically suspended and left as is in an environment at 60° C. for 30 minutes. Subsequently, a 1 kg load is attached to the free end of the measurement sample. The measurement sample is left with the load in the environment at 60° C. for one hour. Then, the displacement (mm) of the measurement sample from its initial position is determined. For a single-faced PSA sheet, backing with PET film is not required.

### Synthetic Example 1

To a reaction vessel equipped with a stirrer, a thermometer and a reflux condenser, were added polycarboxylic acids and polyols at a molar equivalent ratio of 1:1.5 (polycarboxylic acids to polyols). To 100 parts of the polycarboxylic acids and polyols combined, was added 0.05 part of titanium tetraisopropoxide (available from Wako Pure Chemical Corporation) as the polymerization catalyst and the reaction was carried out at 200° C. at 0.1 kPa for about 7 hours to obtain a polymer A with Mn 9,300. As the polycarboxylic acids, were used sebacic acid (SB), isophthalic acid (IP) and terephthalic acid (TP) at a molar ratio SB:IP:TP=37:13:0.1. As the polyols, were used neopentyl glycol (NPG) and a mixture of 1,4-butane diol (BD) and 1.6-hexane diol (HD) at a molar ratio of 23:27. The polymer A had a Tg of −50° C., a hydroxyl value between 2 mgKOH/g and 5 mgKOH/g, and an acid value below 1 mgKOH/g.

### Synthetic Example 2

As the polycarboxylic acids, were used SB, IP and TP at a molar ratio SB:IP:TP=29:20:1. As the polyols, were used NPG and a BD/HD mixture at a molar ratio of 20:30. Otherwise in the same manner as Synthetic Example 1, was obtained a polymer B. The polymer B had a Mn of 23,000, a Tg of −25° C., a hydroxyl value between 1 mgKOH/g and 3 mgKOH/g, and an acid value below 1 mgKOH/g.

### Synthetic Example 3

As the polycarboxylic acids, were used adipic acid (AD), IP and TP at a molar ratio AD:IP:TP=19:30:1. As the polyols, were used NPG, HD and ethylene glycol (EG) at a molar ratio NPG:HD:EG=16:14:20. Otherwise in the same manner as Synthetic Example 1, was obtained a polymer C. The polymer C had a Mn of 13,000, a Tg of 0° C., a hydroxyl value between 6 mgKOH/g and 9 mgKOH/g, and an acid value below 1 mgKOH/g.

### Example 1 to Example 9

### (Preparation of PSA Compositions)

Were mixed and stirred one of the polyester-based polymers A to C obtained in Synthetic Examples 1 to 3, a terpene-phenol resin (product name YS POLYSTER S-145 available from Yasuhara Chemical Co., Ltd.; softening point ˜145° C.; hydroxyl value 70-110 mgKOH/g) and an isocyanate-based crosslinking agent (product name CORONATE L, 75% solution of trimethylol propane/tolylene diisocyanate trimer adduct in ethyl acetate, available from Tosoh Corporation) to have compositions as shown in Table 1 to prepare PSA compositions according to the respective Examples.

### (Preparation of PSA Sheets)

The PSA composition according to each Example was applied to the release face of 38 μm thick polyester release film (product name DIAFOIL MRF available from Mitsubishi Polyester) and was allowed to dry at 110° C. for two minutes to form a 20 μm thick PSA layer. To this PSA layer, was adhered the release face of 25 μm thick polyester release film (trade name DIAFOIL MRF available from Mitsubishi Polyester, 25 μm thick). The resultant was allowed to age at 50° C. for 96 hours. A 20 μm thick substrate-free double-faced PSA sheet was thus obtained, with the two faces protected with the two sheets of release film.

### Reference Example

To a reaction vessel equipped with a stirrer, thermometer, nitrogen inlet, reflux condenser and addition funnel, were added 95 parts of n-butyl acrylate and 5 parts of acrylic acid as monomers, and 233 parts of ethyl acetate as the polymerization solvent. The resulting mixture was allowed to stir under nitrogen flow for two hours. After oxygen was eliminated from the polymerization system, was added 0.2 part of 2,2′-azobisisobutylonitrile and polymerization was carried out at 60° C. for 8 hours to obtain an acrylic polymer solution. The acrylic polymer has a Mw of about 70×10⁴.

To 100 parts of the resulting acrylic polymer, were added 30 parts of a terpene-phenol resin (product name YS POLYSTER S-145 available from Yasuhara Chemical Co., Ltd.; softening point ˜145° C.; hydroxyl value 70-110 mgKOH/g) and 2 parts of an isocyanate-based crosslinking agent (product name CORONATE L, 75% solution of trimethylol propane/tolylene diisocyanate trimer adduct in ethyl acetate, available from Tosoh Corporation) and 0.01 part of an epoxy-based crosslinking agent (product name TETRAD-C, 1,3-bis(N,N-diglycidylaminomethyl)cyclohexane, available from Mitsubishi Gas Chemical Co., Inc.). The resulting mixture was stirred to prepare a PSA composition according to this Example.

Using this acrylic PSA composition, but otherwise in the same manner as Example 1, was prepared a 20 μm thick substrate-free double-faced PSA sheet.

With respect to the PSA sheets according to each Example, were determined the shear holding power (mm), initial peel strength (N/5 mm), post-oleic-acid-immersion peel strength (N/5 mm) and post-ethanol-immersion peel strength (N/5 mm) From the results, were determined the % retentions of bonding strength after oleic acid immersion and ethanol immersion. The results are shown in Table 1.

TABLE 1

| | | Ex. 1 | Ex. 2 | Ex. 3 | Ex. 4 | Ex. 5 | Ex. 6 | Ex. 7 | Ex. 8 | Ex. 9 | Ref. Ex. |
|---|---|---|---|---|---|---|---|---|---|---|---|
| Polyester (parts) | Polymer A | 100 | 100 | 100 | 100 | | | | | | |
| | Polymer B | | | | | 100 | 100 | 100 | | | |
| | Polymer C | | | | | | | | 100 | 100 | Acrylic |
| Tackifier resin (parts) | Terpene-phenol resin | 0 | 40 | 60 | 80 | 0 | 15 | 30 | 5 | 10 | |
| Crosslinking agent (parts) | Isocyanate-based | 4 | 4 | 4 | 4 | 4 | 4 | 4 | 4 | 4 | |
| Shear holding power (mm) | | 0.1 | 0.3 | 0.4 | 0.2 | 0.1 | 0.1 | 0.1 | 0.1 | 0.1 | 0.1 |
| Peel strength (N/5 mm) | Initial | 1.6 | 4.5 | 6.0 | 0.7 | 1.3 | 2.7 | 3.3 | 2.8 | 0.1 | 3.9 |
| | After oleic acid immersion | 1.4 | 4.4 | 5.7 | 0.9 | 1.6 | 2.9 | 2.5 | 3.1 | 0.1 | 3.7 |
| | After ethanol immersion | 0.1 | 2.6 | 3.2 | 0.7 | 0.3 | 1.5 | 3.1 | 2.2 | 0.3 | 0.2 |
| Retention of bonding | After oleic acid immersion | 87% | 97% | 95% | 133% | 118% | 108% | 76% | 110% | 107% | 95% |
| strength (%) | After ethanol immersion | 7% | 58% | 54% | 105% | 25% | 54% | 94% | 81% | 291% | 4% |

As shown in Table 1, with respect to the acrylic PSA (Reference Example), the peel strength significantly decreased after ethanol immersion as compared to the initial peel strength; on the other hand, among the Examples using polyester-based PSA, Examples 2, 3 and 6 to 8 retained at least 1 N/5 mm of peel strength after ethanol immersion. These Examples also showed at least 50% retentions of bonding strength after ethanol immersion. In addition, the polyester-based PSAs according to Examples 2, 3 and 6 to 8 had post-oleic-acid-immersion peel strengths of 2 N/5 mm or greater. This indicates that they have excellent resistance to low-polar compounds. In these Examples, the displacement in the shear holding power test was 0.5 mm or less, exhibiting comparable holding power to that of the acrylic PSA. Especially, the PSA sheets according to Examples 7 and 8 showed high peel strength and retention of bonding strength after ethanol immersion as well as excellent oil resistance and holding power.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2, 3, 4, 5, 6 PSA sheets
10 substrate
21, 22 PSA layers
31, 32 release liners

What is claimed is:

1. A portable electronic device having a touch panel whose display also serves as an input device, wherein
the touch panel can be operated by direct finger touch,
the portable electronic device has components bonded together with a pressure-sensitive adhesive sheet,
the pressure-sensitive adhesive sheet has a pressure-sensitive adhesive layer comprising a polyester-based polymer, and
the pressure-sensitive adhesive sheet has a 180° peel strength of 1 N/5 mm or greater after ethanol immersion.

2. The portable electronic device according to claim 1, that is a portable phone.

3. The portable electronic device according to claim 1, that is a smartphone.

4. The portable electronic device according to claim 1, that is a tablet personal computer.

5. The portable electronic device according to claim 1, that is a wearable device.

6. The portable electronic device according to claim 1, that is a digital camera.

7. The portable electronic device according to claim 1, that is a portable music player.

8. The portable electronic device according to claim 1, that is a portable game device.

9. The portable electronic device according to claim 1, that is an electronic dictionary.

10. The portable electronic device according to claim 1, that is an electronic book.

11. A pressure-sensitive adhesive sheet,
having a pressure-sensitive adhesive layer comprising a polyester-based polymer; and
having a 180° peel strength of 1N/5 mm or greater after ethanol immersion.

12. The pressure-sensitive adhesive sheet according to claim 11, having at least 50% retention of bonding strength after ethanol immersion.

13. The pressure-sensitive adhesive sheet according to claim 11, having a 180° peel strength of 2 N/5 mm or greater after oleic acid immersion.

14. The pressure-sensitive adhesive sheet according to claim 11, showing a displacement of 0.5 mm or less in a shear holding power test carried out with a load of 1 kg at a temperature of 60° C. for one hour.

15. The pressure-sensitive adhesive sheet according to claim 11, having an initial 180° peel strength of 10 N/25 mm or greater.

16. The pressure-sensitive adhesive sheet according to claim 11, wherein the pressure-sensitive adhesive layer comprises less than 80 parts by weight of a tackifier resin to 100 parts by weight of the polyester-based polymer.

17. The pressure-sensitive adhesive sheet according to claim 16, wherein the tackifier resin comprises a tackifier resin having a hydroxyl value of 30 mgKOH/g or higher.

18. The pressure-sensitive adhesive sheet according to claim 11, wherein the polyester-based polymer is crosslinked with a crosslinking agent.

19. The pressure-sensitive adhesive sheet according to claim 11, wherein the pressure-sensitive adhesive layer has a gel fraction of 20% by weight or higher.

20. The pressure-sensitive adhesive sheet according to claim 11, used for fixing a component in a portable device.
